(19) United States
(12) Patent Application Publication
(10) Pub. No.: US 2003/0193726 A1
(43) Pub. Date: Oct. 16, 2003

(54) Active reflection illumination and projection

(76) Inventors: Mark Peter Davidson, Palo Alto, CA (US); Mario Rabinowitz, Redwood City, CA (US)

Correspondence Address: Mario Rabinowitz, 715 Lakemead Way, Redwood City, CA, 94062-3922, US

(21) Appl. No.: 10/124,521

(22) Filed: Apr. 16, 2002

(51) Int. Cl. G02B 5/08; G02B 7/182

(52) U.S. Cl. 359/850; 359/877

(57) ABSTRACT

This invention deals with the broad general concept for active reflection or projection illumination and image formation. A mini-optics reflection and focussing system is presented that ranges from interior illumination, to exterior illumination, to large scale space based illumination, to ordinary and to telescopic image formation. It can be used both as a source of illumination, and to project images, figures, and the written word. This novel system is uniquely distinct and different from prior art direct viewing gyricon displays, allowing it to be more versatile, economical, and practical with broader applications such as dynamic full color displays. In most cases it can operate with greater simplicity and efficiency. Furthermore in its capacity as a high altitude active reflector of solar radiation, it can be utilized to supply illumination, energy, and provide climate control.

### BACKGROUND OF THE INVENTION

1. Field of the Invention

This invention relates generally to method and apparatus for illumination and image projection by an active reflecting mini-optics system of a dynamic ensemble of mini-mirrors. Our system can even produce moving color images from a white light input containing no image information. This contrasts with other schemes which may be characterized as “direct observation light and dark displays.” Further original applications of this invention include interior and exterior lighting, a new kind of spotlight or lighthouse beacon, a building illumination system, a space-based light source for earth illumination, a reflected projection display system, and a low-cost large aperture telescope. Furthermore, the instant invention also teaches active elements such as ferrofluids which operate totally differently than the prior art.

2. Description of the Prior Art

The processes as taught herein are uniquely distinct and different from the prior art. The prior art is limited to “direct observation displays” wherein images are viewed directly. In the prior art no illumination or images are reflected or projected, only an observation is made directly upon twisting balls (gyricon) displays or separable balls displays which are not mirrored, and which do not utilize a ferrofluid. Thus the novel techniques of the instant invention go well beyond the prior art.

Electric or magnetic fields are used to orient or move polarized or charged bi-colored (gyricon) balls in the prior art. Since mirrors are not incorporated in the prior art, none of them utilizes the balls to optically focus, reflect or project light as in our invention. In one embodiment our invention incorporates balls with a shiny planar reflecting surface such as a metallic coating to give a high coefficient of reflectance. When the prior art refers to superior reflectance characteristics, they mean this in the context of displays with individually bicolored balls that are generally black and white in each hemisphere; or separable balls. In fact, the gyricon and separable ball prior art do not teach the focussing of light in any capacity. These verities are evident from an examination of the prior art. A large representative sample of the prior art will now be enumerated and described. This together with the references contained therein constitutes a comprehensive compendium of the prior art.

U.S. Pat. No. 5,754,332 issued to J. M. Crowley on May 19, 1998 deals with gyricon bi-colored balls whose reflectance is comparable with white paper. The object is to produce a monolayer gyricon direct observation ball display.

U.S. Pat. No. 5,808,783 issued to J. M. Crowley on Sep. 15, 1998 deals with gyricon bi-colored balls “having superior reflectance characteristics comparing favorably with those of white paper.” Again the objective is a direct observation ball display application.

U.S. Pat. No. 5,914,805 issued to J. M. Crowley on Jun. 22, 1999 utilizes two sets of gyricon bi-colored balls “having superior reflectance charactreristics comparing favorably with those of white paper” for direct observation ball display purposes.

U.S. Pat. No. 6,055,091 issued to N. K. Sheridon and J. M. Crowley on Apr. 25, 2000 utilizes gyricon bi-colored cylinders. Again the objective is a direct observation display application.

U.S. Pat. No. 6,072,621 issued to E. Kishi, T. Yagi and T. Ikeda on Jun. 6, 2000 utilizes sets of different mono-colored polarized balls which are separable for a direct observation ball display device.

U.S. Pat. No. 6,097,531 issued to N. K. Sheridon on Aug. 1, 2000 teaches a method for making magnetized elements (balls or cylinders) for a gyricon direct observation display.

U.S. Pat. No. 6,120.588 issued to J. M. Jacobson on Sep. 19, 2000 describes a direct observation ball display device which uses mono-colored elements that are electronically addressable to change the pattern of the ball display.

U.S. Pat. No. 6,174,153 issued to N. K. Sheridon on Jan. 16, 2001 teaches apparatus for the purpose of a gyricon direct observation ball display.

U.S. Pat. No. 6,192.890 B1 issued to D. H. Levy and J.-P. F. Cherry on Feb. 27, 2001 is for a changeable tattoo direct observation ball display using magnetic or electric fields to manipulate particles in the ball display.

U.S. Pat. No. 6,211,998 B1 issued to N. K. Sheridon on Apr. 3, 2001 teaches a method of addressing a direct observation ball display by a combination of magnetic and electric means. U.S. Pat. No. 6,262,707 B1 issued to N. K. Sheridon on Jul. 17, 2001 has a similar teaching for a gyricon ball display.

A large number of prior art devices have been described, all of which are directed at addressing and changing the pattern of a direct observation ball display device. While there are other such prior art teachings, none of them teaches or anticipates our invention.

### Definitions

“Bipolar” refers herein to either a magnetic assemblage with the two poles north and south, or an electric system with + and − charges separated as in an electret.

“Compaction” refers to increasing the density of a collection (ensemble) of objects by geometrical arrangement or other means.

“Collimated” refers herein to an approximately parallel beam of light.

“Elastomer” is a material such as synthetic rubber or plastic, which at ordinary temperatures can be stretched substantially under low stress, and upon immediate release of the stress, will return with force to approximately its original length.

“Electret” refers to a solid dielectric possessing persistent electric polarization, by virtue of a long time constant for decay of charge separation.

“Electrophoresis or Electrophoretic” is an electrochemical process in which colloidal particles or macromolecules with a net electric charge migrate in a solution under the influence of an electric current. It is also known as cataphoresis.

“Focussing planar mirror” is a thin almost planar mirror constructed with stepped varying angles so as to have the optical properties of a much thicker concave (or convex) mirror. It can heuristically be thought of somewhat as the projection of thin equi-angular segments of small portions of a thick mirror upon a planar surface. It is a focusing planar reflecting surface much like a planar Fresnel lens is a focusing transmitting surface. The dynamic-focussing property of an ensemble of tiny elements which make up the focussing planar mirror are an essential feature of the instant invention.

“Immiscible” herein refers to two fluids which are incapable of mixing.

“Packing fraction” herein refers to the fraction of an available volume or area occupied by a collection (ensemble) of objects.

“Pixel” refers to the smallest element of an array of elements that make up an image.

“Polar gradient” as used herein relates to magnetic optical elements that are controlled in the non-gyricon mode such as in the magnetic field gradient mode.

“Monopolar” as used herein denotes mono-charged optical elements that are controlled in the non-gyricon mode such as the electrophoretic mode.

“Primary colors” are three colors such as red, green, and blue, or red, yellow, and blue which can be combined (mixed) in various proportions to produce any other color.

“Rayleigh limit” relates to the optical limit of resolution which can be used to determine the smallest size of the elements that constitute a mini-mirror. Lord Rayleigh discovered this limit from a study of the appearance of the diffraction patterns of closely spaced point sources.

“Spin glass” refers to a wide variety of materials which contain interacting atomic magnetic moments. They possess a form of disorder, in which the magnetic susceptability undergoes an abrupt change at what is called the freezing temperature for the spin system.

“Thermoplastic” refers to materials with a molecular structure that will soften when heated and harden when cooled. This includes materials such as vinyls, nylons, elastomers, fuorocarbons, polyethylenes, styrene, acrylics, cellulosics, etc.

“Translucent” as used herein refers to materials that pass or transmit light of only certain wavelengths so that the transmitted light is colored.

### SUMMARY OF THE INVENTION

There are many aspects and applications of this invention, which provides techniques applicable individually or in combination for novel illumination techniques and their applications. Primarily this invention deals with the broad general concept of method and apparatus for active reflection, projection, and focussing of light to produce illumination or images. The illumination and the images may be static or varying. They may be colored with changing intensities and hues, or black and white with shades of grey. As will be described in detail, these objectives may be accomplished by any of a number of ways separately or in combination, as taught by our invention

It is a general object of this invention to provide an illumination planar mini-optic system for active reflection of light which can produce a substantially higher power density than the incident light.

Another objective is to provide a mini-optical colored active reflecting light illumination system.

Another object is to provide a mini-optical active reflecting light display system.

Another object is to provide a mini-optical active reflecting light display system for image formation.

Another object is to provide a mini-optical active reflecting light display system for creating images from a white light input containing no image information.

One aspect of our invention is to provide a mini-optical colored active reflecting light projection system.

Another objective of the present invention is to provide an active reflection space-based light source for illumination of ground, or above ground installations.

Another aspect of our invention is to provide a new kind of active reflection lighthouse beacon,

Another objective is to provide an active reflection building illumination system.

Another object is to provide a novel low-cost large aperture telescope

Other objects and advantages of the invention will be apparent in a description of specific embodiments thereof, given by way of example only, to enable one skilled in the art to readily practice the invention as described hereinafter with reference to the accompanying drawings.

### BRIEF DESCRIPTION OF THE DRAWINGS

FIG. 1 is a cross-sectional view of an electrically charged bipolar sphere with an equatorial flat reflecting surface. This sphere is one of a multitude of optical elements which actively reflect and focus incident light.

FIG. 2 is a cross-sectional view of a magnetically charged bipolar sphere with an equatorial flat reflecting surface. This sphere is one of a multitude of optical elements, which actively reflect and focus incident light.

FIG. 3 is a cross-sectional view of a monopolar electric cell filled with two immiscible fluids, and shiny charged particles of the same sign in the bottom one. This cell is one of a multitude of optical elements which actively reflect and focus incident light.

FIG. 4 is a cross-sectional view of a ferrofluid cell partially filled with a colloidal suspension of shiny ferromagnetic particles in a fluid. This cell is one of a multitude of optical elements which actively reflect and focus incident light.

FIG. 5 is a cross-sectional view of a mini-optics ensemble of elements of two or more populations of sizes to increase the packing fraction and hence the reflectance. Each element actively reflects and focuses incident light.

FIG. 6 is a cross-sectional view of a mini-optics ensemble of elements showing the overlay of a transparent ground plane on top and a resistive grid on the bottom to locally produce varying mini-electric fields for orienting the mini-mirrors to actively reflect and focus incident light.

FIG. 7 is a perspective view of a two-dimensional array of the rotatable elements of an actively reflecting and focussing planar mirror.

FIG. 8 is a schematic top view showing an electronic control grid for rotating the actively reflecting elements of a focussing planar mirror.

FIG. 9 illustrates a 6×6 pixel source of actively reflecting red, green and blue balls.

FIG. 10 illustrates a 3×3 pixel source of actively reflecting red, green and blue balls.

FIG. 11 illustrates a 9×9 pixel source of actively reflecting red, green and blue balls.

FIG. 12 is a cross-sectional view of three actively reflecting translucent spheres, each with an equatorial flat reflecting surface. The spheres are each red, green, and blue to form part of an ensemble of an active pixel source of reflecting elements for color mixing.

FIG. 13 illustrates an actively reflecting system for controllable area illumination.

FIG. 14 illustrates an actively reflecting projection display.

FIG. 15 illustrates an actively reflecting mini-optics building illumination system.

FIG. 16 illustrates an actively reflecting focussed spotlight or lighthouse beacon.

FIG. 17 illustrates an actively reflecting focussed spotlight or lighthouse beacon showing rotation of the beam, although the light source remains stationary.

FIG. 18 illustrates a space-based mini-optics actively reflecting illumination system.

FIG. 19 is a cross-sectional view of an actively reflecting mini-optics large aperture telescope for viewing the image at right angles to the telescope axis.

FIG. 20 is a cross-sectional view of an actively reflecting mini-optics large aperture telescope for viewing the image parallel to the telescope axis.

### DETAILED DESCRIPTION OF THE PRESENTLY PREFERRED EMBODIMENTS

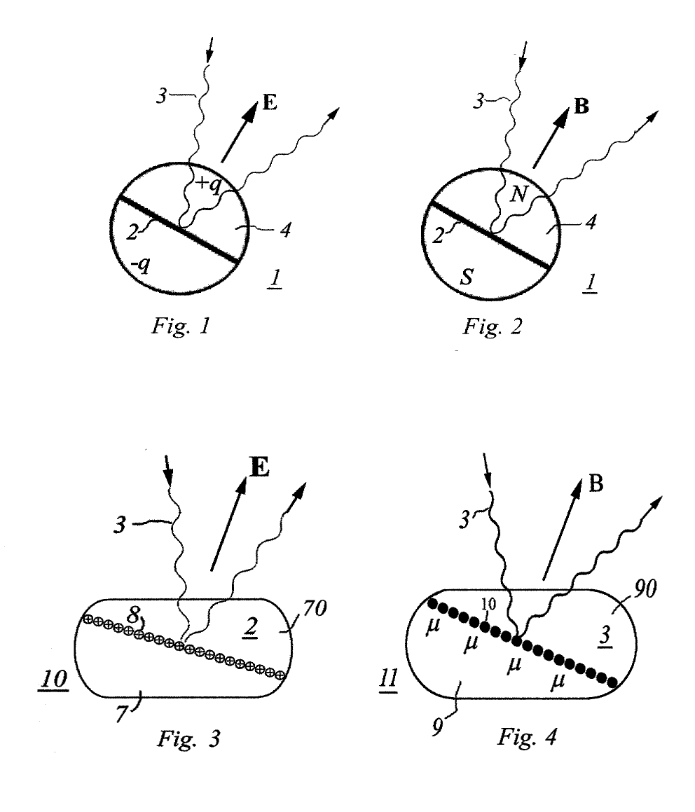

FIG. 1 shows a rotatable element 1 of a focussing planar mini-mirror with an equatorial flat reflecting surface 2 to actively reflect and focus an incident beam of light 3. The element 1 shown is a cross-sectional view of an electrically charged bipolar sphere 4 with charge +q in one hemisphere and charge −q in the opposite hemisphere, that is operated in the well-known electrical gyricon mode. This sphere 4, shown here to operate by means of an electric field E, is one of a multitude of rotatable optical elements 1 which reflect and focus incident light. The active element 1 may operate in any of the well-known gyricon modes, such as electrical monopolar, magnetic, polar gradient, or combination thereof.

It should be noted that the elements in prior art “direct observation display modes” must be able to rotate 180 degrees without binding up, in order to display a generally black or white side up. In the instant invention, a 90 degree rotation of the active element 1 is more than sufficient as this produces a 180 degree reflection of the incident beam of light, since the angle of reflection is equal to the angle of incidence on the active reflecting element 1. Thus a doubling of the angle is produced in the instant invention.

FIG. 2 shows a rotatable active element 1 of a focussing planar mini-mirror with a flat equatorial reflecting surface 2 which reflects and focusses a beam of incident light 3. The element 1 shown is a cross-sectional view of a magnetically charged bipolar sphere 4 with north magnetic field N in one hemisphere and south magnetic field S in the other hemisphere, that is operated in the well-known magnetic gyricon mode. This sphere 4, shown here to operate by means of a magnetic field B, is one of a multitude of active rotatable optical elements 1 which reflect and focus incident light. The material in the top half of element 1 in all the figures needs to be transparent or translucent so the incident light can reach the reflecting surface 2.

The active element 1 may also be operated in any of the well-known gyricon modes, such as electrical monopolar, magnetic, polar gradient, or combination thereof. Two-axis control is possible in mutually orthogonal directions by means of embedded charge +q and −q at top and bottom, and orthogonally embedded magnetic field with north magnetic field N at one end and south magnetic field S at the other end. Two-axis control can also be accomplished with either an E or B field singly.

FIG. 3 shows a fixed element 10 of a focussing planar mini-mirror which is a cross-sectional view of a monopolar electric cell 2 partially filled with a bottom fluid 7 with shiny charged particles 8 of the same sign (shown here as +, but which could also all be −), and a top transparent fluid 70. The two fluids are immiscible. When an electromagnetic field E is applied, the particles 8 coalesce to form a flat reflecting surface at the interface between fluid 7 and fluid 70, as also influenced by surface tension and meniscus. Fluid 70 could be air, but a transparent fluid of substantially less density than fluid 7 is preferred so that gravity will act to maintain their relative top/bottom orientations. If the particles 8 are small enough to form a colloidal suspension, the density of the particles 8 and the fluid 7 may differ. However, it is generally preferable to have the density of the particles 8 approximately matched to the fluid 7.

The orientation of this flat active reflecting surface formed by the shiny charged particles 8 can be controlled by an electric field E to reflect incident light 3. Until E is applied, as an optional capability the particles 8 and the fluid 7 can function as a transparent window when the particles 8 are nanosize i.e. much smaller than the wavelength of the incident light and the fluid 7 is transparent or translucent while they are dispersed in the fluid 7. For the case of dispersed transparency, the particles 8 should be <4000 Å (4×10⁻⁷ m). This cell 2 is one of a multitude of optical elements 1 which reflect and focus incident light 3. The particles 8 may include a wide variety of electomagnetically interactive materials such as electret, optoelectric, conducting, thermoelectric, electrophoretic, resistive, semiconductive, insulating, piezoelectric, magnetic, ferromagnetic, paramagnetic, diamagnetic, or spin (e.g. spin glass) materials. It should be noted that the active reflecting area remains constant for spherical and circular-cylindrical cells, as the orientation of the reflecting surface changes. However, the change in reflecting area with orientation is not a serious problem for the non-spherical, non-circular cell geometry shown.

FIG. 4 shows a fixed element 11 of a focussing planar mini-mirror which is a cross-sectional view of a ferrofluid cell 3 partially filled with a ferrofluid 9 containing shiny ferromagnetic particles 10 of high permeability μ, and a top transparent or translucent fluid 90. The two fluids are immiscible. When an inhomogeneous electromagnetic field B of increasing gradient is applied, the particles 10 are drawn to the region of increasing gradient and coalesce to form an active flat reflecting surface, as shown, at the interface between fluid 9 and fluid 90, as also influenced by surface tension and meniscus. Fluid 90 could be air or a transparent fluid of substantially less density than fluid 9 so that gravity will act to maintain their relative top/bottom orientations. The orientation of the active flat reflecting surface can be controlled by B to reflect incident light 3. This cell 3 is one of a multitude of optical elements 1 which reflect and focus incident light 3. The particles 10 are small enough to form a colloidal suspension, and are coated to prevent coalescence until B is applied, as is well known in the art. It should be noted that the reflecting area remains constant for spherical and circular-cylindrical cells, as the orientation of the active reflecting surface changes. However, the increase in reflecting area as the fluid 9 is inclined, is not a serious problem for the non-spherical, non-circular cell geometry shown.

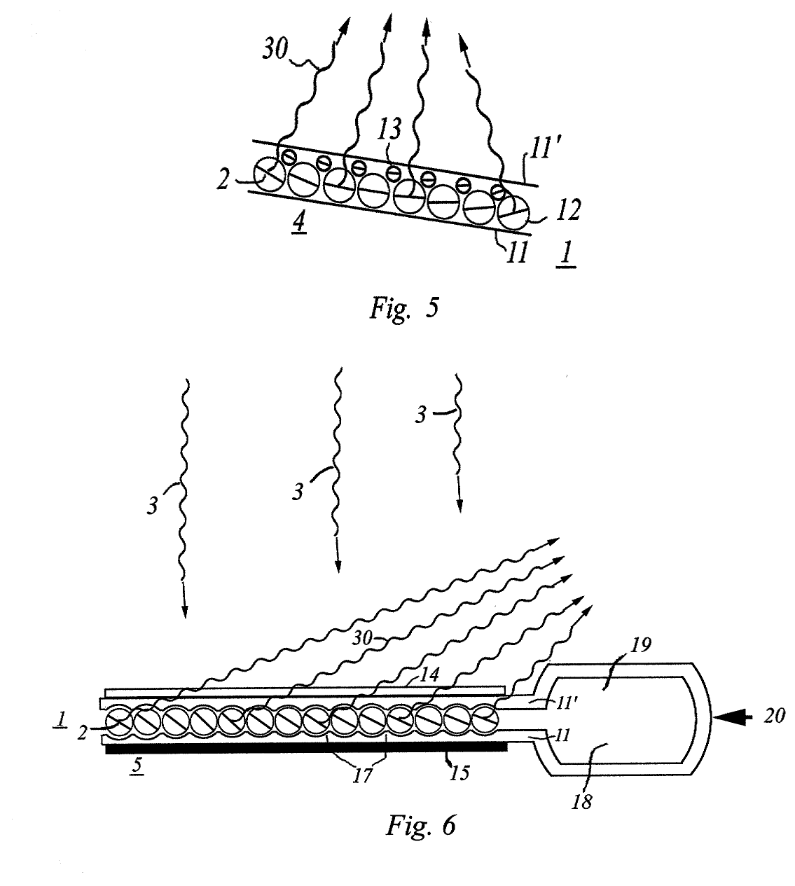

FIG. 5 is a cross-sectional view of a mini-optics ensemble 4 of rotatable elements 1 of two or more populations of particle sizes to increase the packing fraction and hence increase the energy of the reflected wave 30. The particles are contained between two elastomer sheets 11 of which the top sheet 11 is transparent. The large particles 12 and the small particles 13 can already be rotatable, or rendered rotatable by expanding the elastomers 11 by the application of a fluid thereto. The small particles 13 are disposed in the interstices of the monolayer arrangement of the large particles 12. Thus the small particles 13 just fit into the small pockets created by the conjunction of the large particles 12, to create more reflecting area than the very small area that these small particles 13 block of the large particles 12. Each element 1 actively reflects and focuses incident light.

Let us here consider the packing (compaction) of spheres in broad terms so that we may better understand the various trade-offs that may be undertaken in the choice of one set of particles 12 versus two sets of particles 12 and 13, or more; and the relative advantages that are also a function of the packing array. With one set of particles 12 of radius R in a square monolayer array in which any adjacent four particles have their centers at the corners of a square, the maximum packing fraction of circular mirrors is 0.785.

This means that as much as 21% the reflecting area is wasted, with less than 79% of the area available for reflection. If a second population of particles 13 are put into the interstices, their radii would need to be just slightly greater than

rₛ>R[√2−1]=0.414R

so that they would fill the interstices of a monolayer of spheres (first population), and yet not fall through the openings. The maximum packing fraction in square array of two such sets of circular mirrors is 0.920. Thus just by the addition of a second population of particles 13, of the right size, the reflecting area can increase from about 79% to about 92% in a square array.

Now let us consider one set of particles 12 of radius R in a hexagonal monolayer array in which any adjacent six particles have their centers at the corners of a hexagon. In this case, the maximum packing fraction of the circular mirrors is 0.907. This means that only about 10% the reflecting area is wasted, with about 90% of the area available for reflection with one population of particles 12, by just going to a hexagonal array. If a second population of particles 13 are put into the interstices, their radii would need to be just slightly greater than

$${r}_{h} > R [ \frac{2}{3} \sqrt{3} - 1 ] = 0.155 R$$

so that they would fill the interstices of a monolayer of an hexagonal array of spheres (first population of particles 12), and yet not fall through the openings. The maximum packing fraction in hexagonal array of two such sets of circular mirrors is 0.951. Thus just by the addition of a second population of particles 13, of the right size, the reflecting area can increase from about 90% to about 95% in an hexagonal array.

The following two tables summarize the above results on packing fractions.

TABLE 1
Comparison of Hexagonal and Square Packing Fractions

| | PF1 | PF2 | PF2/PF1 |
|---|---|---|---|
| Hexagonal Packing | 0.907 | 0.951 | 1.049 |
| Square Packing | 0.785 | 0.920 | 1.172 |

TABLE 2
Relative Gain of Hexagonal versus Square Packing

| PFh1/PFs1 | PFh2/PFs2 | PFh2/PFs1 |
|---|---|---|
| 1.155 | 1.034 | 1.211 |

Interesting conclusions can be drawn from TABLES 1 and 2 which can be guides for design tradeoffs even though the calculated quantities are upper limits of what can be attained in practice. TABLE 2 shows that just by going from a square monolayer array to an hexagonal monolayer array the reflecting area can be increased by about 16%. When two populations of particles 12 and 13 are used, there is only about a 3% improvement by going to an hexagonal array. The largest improvement is about 21% for a two population hexagonal array compared with a one population square array.

FIG. 6 is a cross-sectional view of a mini-optics ensemble 5 of an individually rotatable monolayer of elements 1 showing the overlay of a transparent ground plane 14 on top and a resistive grid 15 on the bottom to locally produce varying mini-electric fields for orienting the mini-mirrors 2 to focus the incident light 3 as concentrated light of the reflected wave 30. The rotatable elements 1 are situated in ridged cells 17 between two elastomer sheets. For spherical or cylindrical elements 1 the ridged cellular structure 17 is conducive to holding the elements in grid position in the array structure. For elements 1 of disk shape, the ridged cells 17 are a valuable adjunct in maintaining the array structure and avoiding binding between the elements 1. When rotation of the elements 1 is desired, the effect of the torque applied by the field can be augmented by injecting a fluid 18 from a plenum reservoir 19 by a pressure applying means 20 to expand the separation of the sheets 11. It is desirable to utilize a fluid 18 whose index of refraction matches a transparent or translucent hemisphere or hemicylinder. In addition to providing a means to pressure the elastomer sheets 11 apart, the fluid 18 acts as a lubricant to permit the elements 1 to rotate freely when being guided into the proper orientation.

The ridged cells 17 can be created in thermoplastic elastomer sheets 11 by heating the sheets 11 to a slightly elevated temperature and applying pressure with the elements 1 between the sheets 11. In the case of elements 1 of disk shape 5, the ridged cells 17 can be created on each sheet individually. This gives twice the height for the cells, when two such sheets are put together to hold the elements 1.

A presently preferred maximum for the diameter of elements 1 is −10 mm or more. The minimum diameter of elements 1 can be assessed from the Rayleigh limit

$$d = \frac{0.61 λ}{n sin u} ∼ 10 λ ,$$

where d is the minimum diameter of elements 1, λ˜4000 Å is the minimum visible wavelength, n is the index of refraction ˜1 of element 1 (the medium in which the incident light is reflected), and u is the half angle of the light beam admitted by elements 1. Thus d˜40,000 Å (4×10⁻⁶ m) is the minimum diameter of elements 1.

If the focussing planar mini-mirrors concentrate the incident light by a factor of 100, the total increase in power density at a receiving surface is 100 times greater than directly incident light from the same distance. Thus a much brighter image or illumination is possible than just from the light source alone.

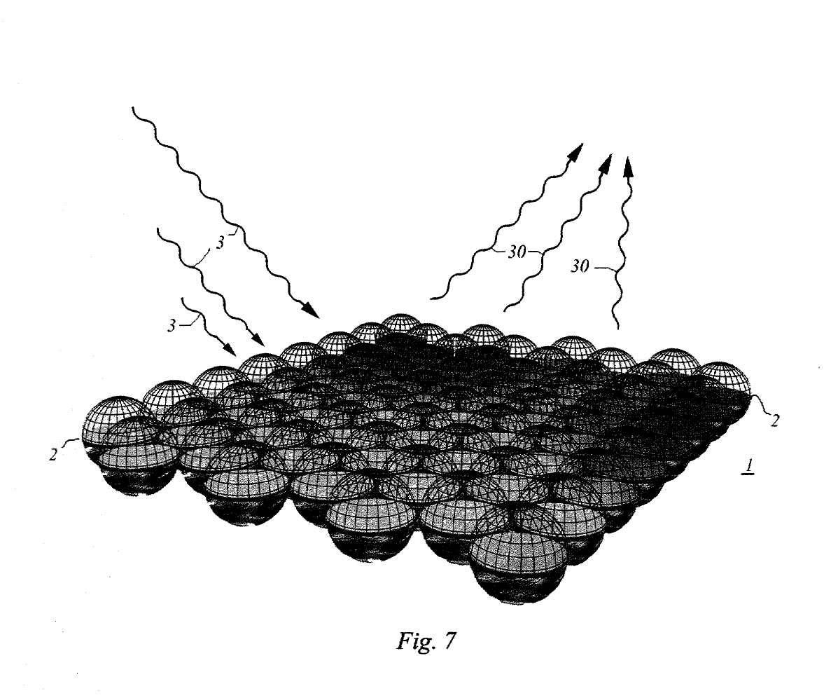

FIG. 7 is a perspective view of a two-dimensional array of the rotatable elements 1 of a focussing planar mini-mirror with an active equatorial flat reflecting surface 2 which reflects incident light 3 and focuses it as a concentrated light wave 30 unto a receiving surface.

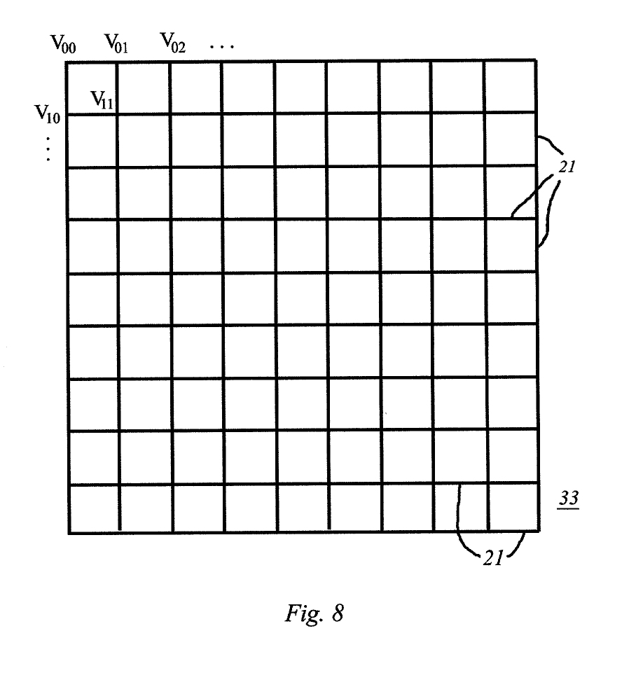

FIG. 8 is a schematic top view showing an electronic control grid 33 for rotating the active reflecting elements of a focussing planar mini-mirror. The elements 1 are capable of rotating in any direction (two-axis response) in responding to a selectively applied electric field by the electronic control grid 33. The electronic control grid 33 is made of resistive components 21. The mini-mirror/lens array with elements 1 is sandwiched between the resistive electronic control grid 33 (15 in FIG. 6) shown here and the transparent ground plane 14 as shown in the cross-sectional view of FIG. 6. The orientation of the elements 1 is determined by controlling the voltages V at the nodes of the grid such as those shown V₀₀, V₀₁, V₀₂, V₁₀, V₁₁ with voltage Vᵢⱼ at the ij th node. The voltage Vᵢⱼ can be controlled by a small inexpensive computer with analog voltage ouputs. The electronic control grid 33 is similar in construction and function to analogous grids used in personal computer boards, and in flat panel monitors. Similarly, small current loops around each cell provide local magnetic fields for the orientation function of elements with magnetic dipoles.

The voltage between successive nodes produces an electric field in the plane of the planar mini-mirror, and the voltage between a node and the ground plane produces an electric field perpendicular to the planar mini-mirror to control the orientation angle of the active reflecting/focussing mini-mirrors. The number of elements 1 per grid cell is determined by the degree of focussing desired: the higher the degree of focussing, the fewer the number of elements 1 per grid cell. In the case of elements 1 which contain a combination of orthogonal electrical and magnetic dipoles, the orientation function may be separated for orientation in the plane and orientation perpendicular to the plane by each of the fields.

After being positioned for optimal focussing angles of reflection, active elements 1 may be held in place by the elastomer sheets 11 (cf. FIGS. 5 and 6) with the voltages Vᵢⱼ being turned off to eliminate unnecessay power dissipation. When a new angular orientation of the elements 1 and 2 is desirable, the sheets 11 (cf. FIG. 6) are separated by injecting a fluid 18 from a plenum reservoir 19 by a pressure applying means 20. In the case of elements 10 (cf. FIG. 3) the reflecting angle needs to be held fixed by the control function such as the electronic control grid 33. To minimize power dissipation in this case it is desirable to make resistive components 21 highly resistive so that a given voltage drop is accomplished with a minimum of current flow and hence with a minimum of power dissipation.

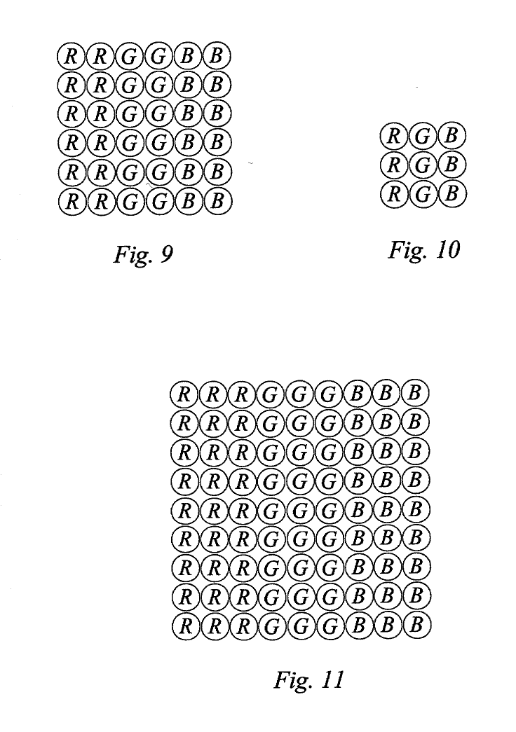

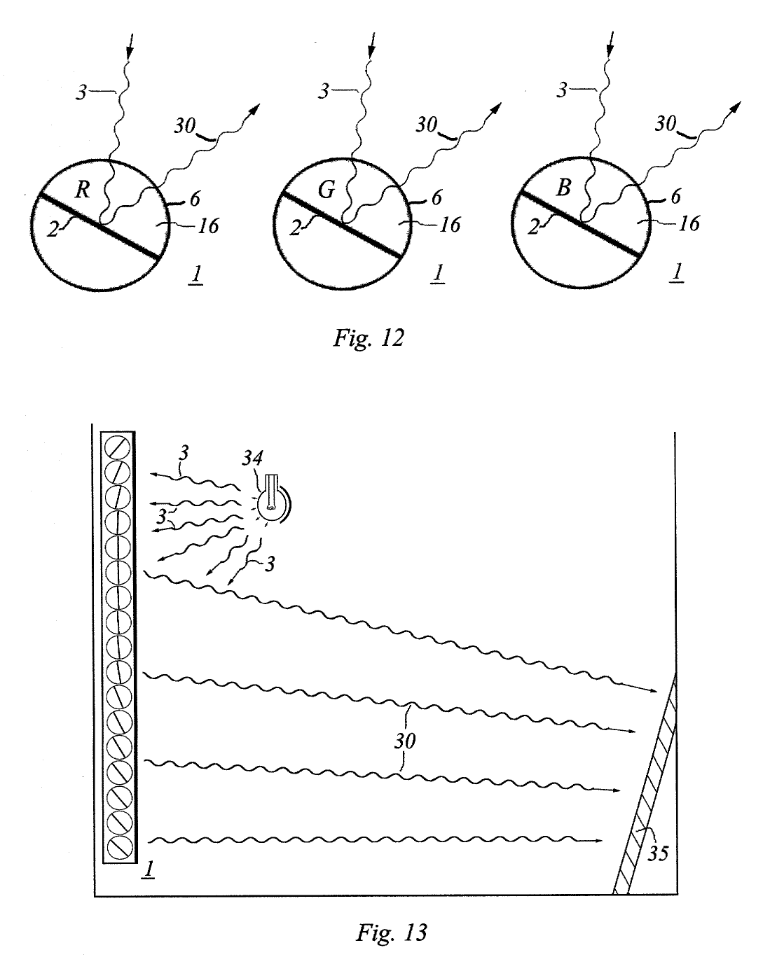

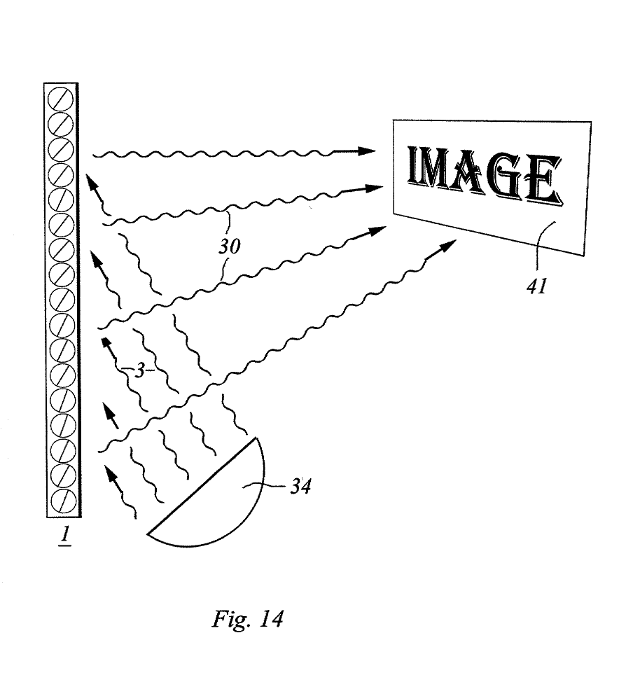

FIG. 9 is a cross-sectional top view showing a 6×6 pixel source reflector of primary colors red, green and blue balls. The size of the pixel source may be smaller, such as 3×3, as shown in FIG. 10. Or it may be larger, such as the 9×9 pixel source reflector of primary colors red, green and blue balls as shown in FIG. 11. The more elements of each color in a pixel, the finer the gradation of the possible intensity steps that may be taken to mix the primary colors. In FIG. 9, since there are 12 balls of each color, the primary color intensity step size is 1/12=8.3% which for many applications is a presently preferred embodiment as it does not burden the computer nor the array with too many balls to handle, and yet gives reasonable color replication. In FIG. 10, there are only 3 red balls, 3 green balls, and 3 blue balls, limiting the primary color intensity step size to ⅓=33.3%. In FIG. 11, since there are 27 balls of each of the primary colors, the primary color intensity step size is 1/27=3.7%. A given ball can either add to the amount of primary color falling on a pixel, or it can be eliminated. Elimination is achieved by either 180° rotation of a ball so that no light is reflected from it, or rotation by an angle less than 180°, that serves to remove the light reflected from it to a non-critical location.

Since the balls may be individually rotated, for a given ensemble of balls in the mini-optics active reflection array, the number of balls contributing to the creation of a given color pixel may be varied and may come from various non-contiguous locations in the array, as long as they are focussed on the same pixel spot on the receiving surface. Thus it is possible to utilize all the balls, as the color from a given ball may be combined with those from distant balls for a given pixel. The mini-optics active reflection array has an advantage over other schemes as the primary colors may be focussed on the same spot, or just close together as is done on TV screens and computer monitors. Focussing the primary colors on the same spot, increases resolution capability.

If a color image is desired, the creation of color is necessary when the light source is neutral such as white, and this can be achieved with mirrored primary colored balls as has been discussed. Neutral (uncolored) transparent balls with active reflecting mirrors can form colored images when the light incident on them is colored. For example, light from a color transparency reflected from neutral transparent balls will form a colored image on a receiving surface. Another method to produce a color image is to use three or more colored beams which would be incident on non-overlapping areas of the reflecting array. In this case the reflecting balls are simply transparent with no color. The incident beams provide the color. Each pixel of the image would be a superposition of light from reflecting elements in each color zone.

The advantage of primary color balls over colored beam systems is that only a single light source is required and that the registration accuracy of the light source is easier to achieve because the reflecting elements can be close together. Moreover, by keeping the reflecting elements for a single image pixel close together, the color balance will be easier to maintain as efficiencies of the different reflecting elements making up the pixel will tend to vary in proportion if either the source or the image is moving in time, whereas if the reflectors are widely separated in the reflecting array, but are directing light to the same image pixel, then their relative intensities may vary if either the source or the image location varies with time. Thus the primary color balls have advantages such as intensity and resolution over colored beams.

Primary colors are three colors such as red, green, and blue, or red, yellow, and blue which can be combined (mixed) in various proportions to produce any other color. This is an experimental fact, independent of any theory of color vision. Contrary to common misunderstanding, the choice of primaries is somewhat arbitrary. One may transform a given set of primary combinations into another by established quantitative algorithms. Although this system works very well for laboratory measurements, there are limitations with respect to humans due to visual variabilities. Normal human observers are not able to agree precisely about color matches due to the differential absorption of light in front of their photorecptors. There are much larger differences for the ˜4% of the population whose color vision is abnormal. Furthermore, the system works only for an intermediate range of intensities (brightness), below which the eye's rods (the receptors of night vision) interfere, and above which a bleaching of the eye's visual photopigments alters the absorption characteristics of the eye's cones. Therefore in producing or reproducing given color patterns, these limitations need to be taken into consideration.

FIG. 12 is a cross-sectional view of three actively reflecting translucent spherical elements 1, each with an equatorial flat reflecting surface. The top hemispheres of spheres 1 are each red, green, and blue to form part of an ensemble of an active pixel source of reflecting elements for color mixing. The incident light 3 is transmitted (passes) through the outer translucent surface 6 and through the translucent medium 16 to the reflecting surface 2. The reflected light 30 then goes out through the medium 16 and the outer surface 6. The outer surface 6 and the medium 16 may both be of the same translucent color, or one may be transparent and the other translucent. Light 30 that is red, green, and blue respectively is shown emerging left to right from the spherical elements 1. Image formation does not depend on colors and images being present in the source light (which may be white and contain no information) since the balls may be programmed to produce images independent of the incident light 3.

FIG. 13 illustrates an actively reflecting system for controllable area illumination. A light source 34 sends incident light 3 to a mini-optics ensemble of reflecting elements 1, which reflects and focusses the reflected light 30 unto a surface 35. This permits the illuminated area to be controlled in intensity, area, and color. All these parameters may be varied as a function of time and space to create a new dimension in interior design. This system can replicate the balanced spectrum of natural light. It can create natural, glare-free light to allow one to see with comfort and ease, even in a windowless room. It can provide sharp visibility. It can make the illuminated surface 35 uplifting, cheerful and bright for reading, for hobbies, for working, as well as providing a relaxing living or work space. This mini-reflecting light source can produce a changeable artistic design of emanating light in the space between the light source 34, the walls, and on all impinged surfaces.

FIG. 14 illustrates an actively reflecting projection display. A light source 34 sends incident light 3 to a mini-optics ensemble of reflecting elements 1, which reflects and focusses the reflected light 30 to form an IMAGE 41. The image 41 may vary from written material to artistic scenery, and from black and white to colored. The image 41 may be large or small; and may be interior or exterior as on the facade of a building. The image 41 may produce a light display on building walls. The image 41 may make the illuminated surface into a panorama of changing shapes and color designs. This mini-optics ensemble of reflecting elements 1 can produce information such as advertising and figures on an impinged surface such as a wall. Instead of writing on sheets with the balls inside as in the prior art, the instant invention creates on a separate surface: writing, color images, and much more than can be done by the prior art.

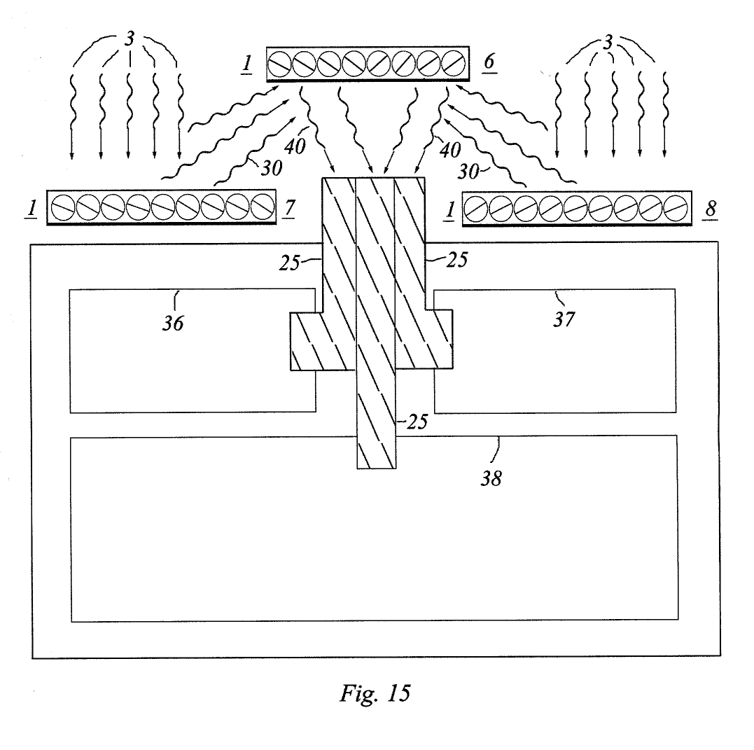

FIG. 15 illustrates an actively reflecting mini-optics building illumination system. Shown are a cross-sectional view of three sets of mini-optics ensembles 6, 7, and 8 of rotatable elements 1 wherein sunlight 3 is incident on the first ensemble 6 and the reflected light 30 from this first ensemble 6 is focussed on the second and third ensemble 7 and 8 to reflect light 40 which is further concentrated and focussed onto transmitters 25 (such as fiber optics cable) to be piped into a building structure. The degree of concentration of solar light 40 reaching the transmitters 25 is increased by utilizing two or more focussing planar mini-mirrors 6, 7, and 8 as shown. The transmitters 25 bring this light 40 to illuminate various rooms 36, 37, and 38 of the building which many also utilize actively reflecting mini-optics ensembles. The sun's light may be transmitted by means other than a fiber optic bundle to be piped to various rooms. For example, the sun's light may be reflected to a series of other reflectors (either ordinary or mini optics reflectors such as 6, 7, and 8) to disperse it into the building.

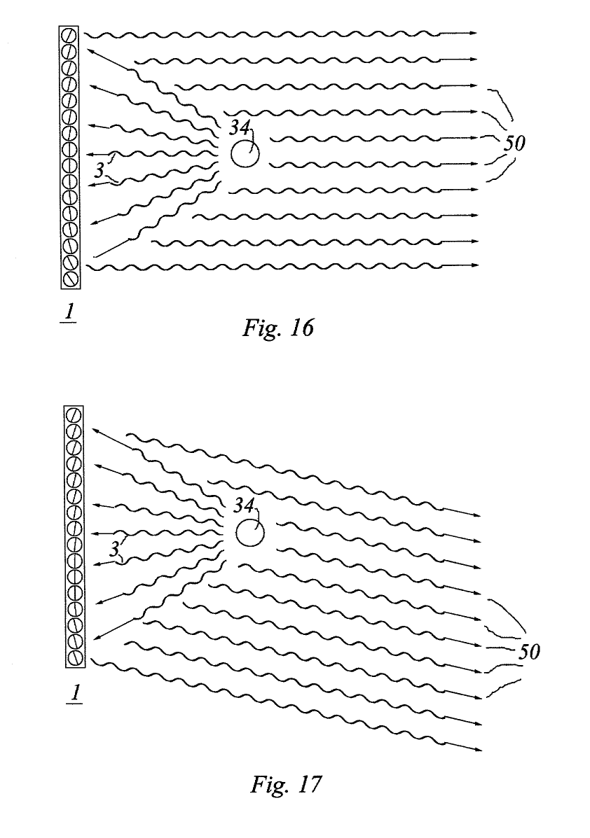

FIG. 16 shows in cross-section an actively reflecting focussed spotlight or lighthouse beacon wherein a primary light source 34 sends light 3 incident onto a mini-optics ensemble of reflecting elements 1, which reflect and form a colliminated parallel beam of light 50. In this lighthouse beacon or spot light, the primary light source 34 can remain stationary, and the mini-optics ensemble of reflecting elements 1 does the rotating to move the light beam around.

The following equations govern the reflecting geometry, where:

S is the location of a point light source, Cartesian coordinates (sx,sy,sz).

D is the point at which light is to be focused onto, Cartesian coordinates (dx,dy,dz).

O is the center of the mirror, Cartesian coordinates (ox,oy,oz).

N is the unit vector pointing normal to the mirror plane from the point O.

Assume that S, D, and O are not collinear. Then in order that light from S be reflected onto D it is necessary that N lies in the plane of SDO, and that it bisects the angle s(S,O,D). The unit vector N determines the angle for a given mirror in the array to accomplish the desired focussing for all the embodiments that are shown in the various figures.

We may calculate the unit vector N with the following formulas

\vec{S}−\vec{O}=(sx−ox,sy−sz−oz) (1)

|\vec{S}−\vec{O}\sqrt{(sx−ox)²+(sy−oy)²+(sz−oz)²} (2)

\vec{D}−\vec{O}=(dx−ox,dy−oy,dz−oz) (3)

\vec{D}−\vec{O}=(dx−ox)²+(dy−oy)²+(dz−oz) (4)

$$N = \frac{\frac{{S}^{->} - {O}^{->}}{\vert {S}^{->} - {O}^{->} \vert} + \frac{{D}^{->} - {O}^{->}}{\vert {D}^{->} - {O}^{->} \vert}}{\vert \frac{{S}^{->} - {O}^{->}}{\vert {S}^{->} - {O}^{->} \vert} + \frac{{D}^{->} - {O}^{->}}{\vert {D}^{->} - {O}^{->} \vert} \vert} \qquad ( 5 )$$

If the source point is very distant, then the incoming radiation is collimated and the direction of the line SO becomes independent of the point O. Likewise, if the detector point D is very distant, then the reflected rays aimed at D are all parallel. An example where the source point is distant is where the reflecting mirror system is being used to reflect sunlight, or starlight as for a telescope. An example where the detector point is very far away, is when the reflecting mirror system is being used as a spotlight or lighthouse beacon.

FIG. 17 illustrates an actively reflecting focussed spotlight or lighthouse beacon showing rotation of the beam, although the light source remains stationary. Shown in cross-section is an actively reflecting focussed spotlight or lighthouse beacon wherein a primary light source 34 sends light 3 incident onto a mini-optics ensemble of reflecting elements 1 which have rotated to reflect and form a colliminated parallel beam of light 50 in a new direction, without motion from the light source 34. Among the advantages of this mode of operation is the ease of beam rotation compared to rotating a light source 34 which may have a large moment of inertia. Another advantage is that the support structure for the light source 34 does not have to withstand a large centrifugal force.

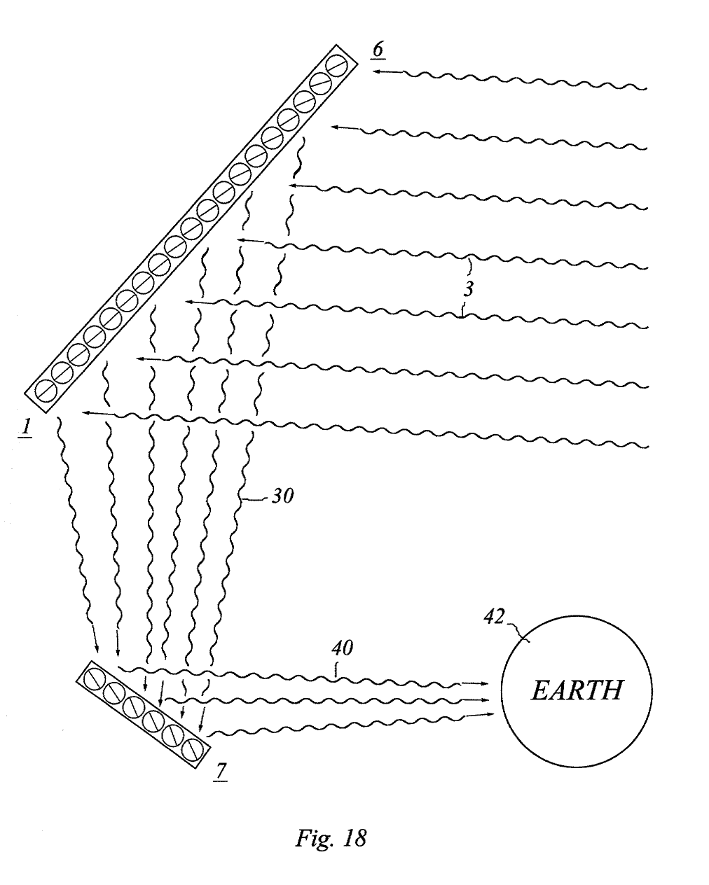

FIG. 18 illustrates a space-based orbiting mini-optics actively reflecting illumination/energy system. Shown are a cross-sectional view of two sets of mini-optics ensembles 6, and 7 of rotatable elements 1 wherein sunlight 3 is incident on the first ensemble 6 and the reflected light 30 from this first ensemble 6 is focussed on a second ensemble 7 to reflect light 40 which is further concentrated and focussed onto a collecting region of the EARTH 42.

To illustrate the amplification capability of this configuration, in the ideal case where all the incident light is reflected without absorption or losses, if the two sets of focussing planar mini-mirrors each concentrated the light energy by a factor of 10, the total increase in power per unit area reaching the collector would be a factor of 10²=100 times greater than the incident power density. For n such reflectors each feeding into the other until finally reaching the collector, the increase would be 10ⁿ. In this process, as in any passive optical system, the brightness as measured in power per unit area per solid angle cannot be increased, and so there is an upper limit to the concentration. Optical aberrations would cause the concentration to fall short of this ideal. In practice, each successive stage of concentration would become less effective due to aberrations as it must focus light having larger and larger cone angle and consequently more severe aberrations. If the light source is thermal radiation at temperature T, then the second law of thermodynamics places a limit on the brightness of the radiation such that it can never be brighter than black body radiation at that same temperature. In this case the radiation can also never be used to passively heat an object to a temperature greater than T. For the sun, the temperature of the radiation reaching the earth is about 6,000 degrees Kelvin.

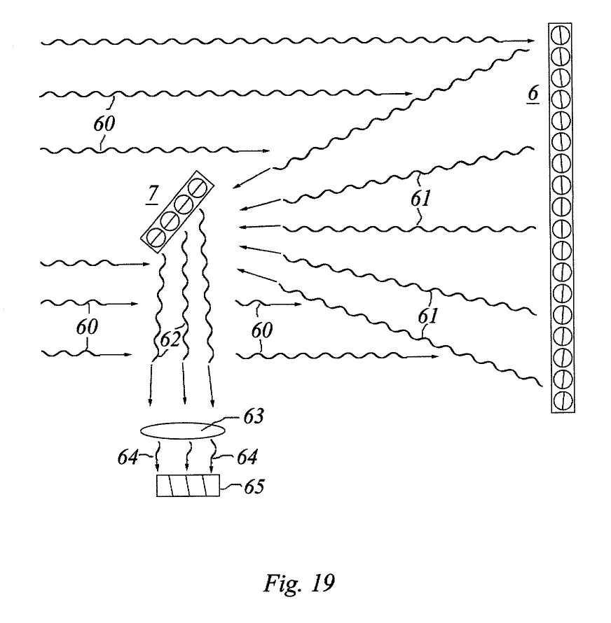

FIG. 19 is a cross-sectional view of an actively reflecting mini-optics large aperture telescope for viewing the image at right angles to the telescope axis. Shown are a cross-sectional view of two sets of mini-optics ensembles 6 and 7 of rotatable elements 1 wherein starlight 60 is incident on the first ensemble 6. The reflected light 61 from this first ensemble 6 is focussed on a second ensemble 7 where it is reflected at right angles as light 62. (A small plane mirror or totally reflecting prism may be used instead of the ensemble 7.) Light 62 is further concentrated and focussed onto a lens system 63 which sends the transmitted light 64 to an imaging detector 65. The imaging detector 65 may be a camera, photocells, photomultiplier, or other imaging devises.

Most astronomical observations are no longer made visually, but rather photographically or electronically. That is why modern astronomical telescopes are more precisely cameras rather than telescopes. Most of the big telescopes make use of large, heavy, expensive, concave mirrors which must be ground to great precision. These cumbersome mirrors must be supported carefully to maintain their precision. They are vulnerable to temperature changes which can distort their optical properties. The actively reflecting mini-optics of the instant invention avoids these problems by active electronic adjustment of the individual mimi-mirrors, even after installation. Thus larger overall aperture and lower cost is possible than with bulky, cumbersome ground glass telescopic mirrors. The virtue of the instant invention is the capability for a large light gathering aperture area, which would presently be at the expense of lower resolution.

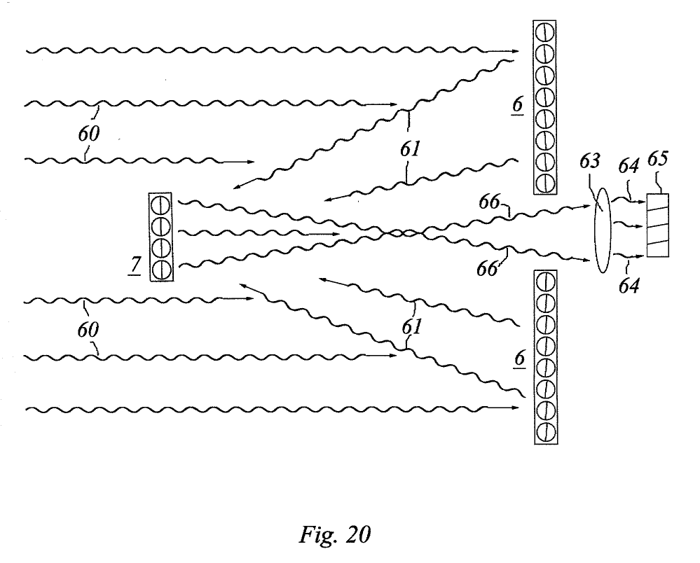

FIG. 20 is a cross-sectional view of an actively reflecting mini-optics large aperture telescope for viewing the image parallel to the telescope axis. Shown are a cross-sectional view of two sets of mini-optics ensembles 6 and 7 of rotatable elements 1 wherein starlight 60 is incident on the first ensemble 6. The light 61 from this first ensemble 6 is focussed on a second ensemble 7 where it is reflected and focussed as light 66. (A small convex mirror may be used instead of the ensemble 7. Another possibility is to replace the ensemble 7 with the imaging detector 65 so no opening would be necessary in the ensemble 6.) Light 66 is further concentrated and focussed onto a lens system 63 which sends the transmitted light 64 to an imaging detector 65. Equations 1-5 presented in conjunction with FIG. 16 can determine the proper angles of the mirrors in the mini-optics ensembles 6 and 7 of the telescopes of FIGS. 19 and 20, as well as all the other devices of the instant invention.

While the instant invention has been described with reference to presently preferred and other embodiments, the descriptions are illustrative of the invention and are not to be construed as limiting the invention. Thus, various modifications and applications may occur to those skilled in the art without departing from the true spirit and scope of the invention as summarized by the appended claims.

1. A miniature reflecting optics system for projecting light, comprising:
(a) at least one rotatable miniature reflector positioned in the space between two sheets holding said rotatable miniature reflector;
(b) the top sheet of said two sheets being transparent; and
(c) means to individually rotate said reflector within said sheets.

2. The apparatus of claim 1, wherein each said rotatable miniature reflectors include at least one red reflector, one yellow reflector, and one blue reflector.

3. The apparatus of claim 1, wherein each said rotatable miniature reflectors include at least one red reflector, one green reflector, and one blue reflector forming a pixel of said projecting light.

4. The apparatus of claim 1, wherein each said rotatable miniature reflector is a sphere comprising:
(a) a reflector embedded in said sphere; and
(b) bipolar charge of opposite sign in each of the two hemispheres of said sphere.
